(19) United States
(12) Patent Application Publication
(10) Pub. No.: US 2005/0194750 A1
(43) Pub. Date: Sep. 8, 2005

(54) Seal device

(76) Inventor: Thomas C. Wallace, Englewood, CO (US)

Correspondence Address: John M. Harrington;Kilpatrick Stockton LLP, 1001 West Fourth Street, Winston-Salem, NC, 27101, US

(21) Appl. No.: 11/073,443

(22) Filed: Mar. 7, 2005

Related U.S. Application Data
(60) Provisional application No. 60/550,283, filed on Mar. 5, 2004.

(51) Int. Cl. F16J 15/34

(52) U.S. Cl. 277/603

(57) ABSTRACT

A seal device adapted for placement between two flanges is provided comprising an annular seal member having two faces, and inner radius defining a central aperture, and an outer radius defining the radially outer edge of the seal member, a radially inner channel formed between said faces and being open to said central aperture, and a radially outer groove open to the radially outer edge of said seal member, a seal retainer surrounding said seal member and located radially outward therefrom, said seal retainer being sized to engage and extend at least partially into the radially outer groove on said seal member, and a resilient member disposed within said annular seal member between a radially innermost portion of said seal retainer and a radially innermost portion of said groove, wherein said radially innermost portion of said seal retainer contacts and supplies a force to said resilient member.

### CROSS REFERENCE TO RELATED APPLICATIONS

The present application claims priority under 35 U.S.C. § 119(e) from U.S. Provisional Patent Application Ser. No. 60/550,283, filed Mar. 5, 2004, entitled “Fully Encapsulated Spring-Energized Internal Face Seal Gasket”, the disclosure of which is incorporated herein by reference.

### FIELD OF THE INVENTION

The present invention relates to sealing devices for creating a seal between the sealing faces of joined pieces in a fluid flow line. More particularly, the present invention is particularly well suited for sealing applications involving high-pressure, cycling conditions, and sealing with relatively low face loads applied.

### BACKGROUND OF THE INVENTION

Seal devices have been used in a variety of applications to prevent fluid from leaking between joined pieces. For example, a seal device is interposed and compressed between flanged end-connections of a flow line where in-line process control equipment is installed. In-line process control equipment includes valves, pumps, flow meters, temperature and pressure controllers and the like. This equipment usually cannot be welded into the flow line because time-scheduled maintenance requires temporary removal of this equipment and, occasionally, depleted equipment must be removed for replacement. In-line process control equipment is used in a variety of industries such as the chemical industry for processing, transporting and dispensing a myriad of chemicals and chemical compounds as well as the oil and gas industry for recovering, distributing and processing oil, gas and by-products thereof.

There are several reasons why the efficacy of a seal device is important to the user. First, failure of the seal device could cause significant environmental damage. Second, a high capital investment is typically associated with transporting fluids through a flow line system and leakage of the fluid must be prevented to protect this expensive system from potential damage. Third, a high labor cost is often associated with repair of a damaged flow line system. Numerous problems cause seal devices to leak. Such problems include corrosion, over-torqueing, under-torqueing, temperature, pressure and velocity of the fluid, to name a few.

Most any fluid can be considered corrosive. For example, even water might be considered slightly corrosive if its pH deviates from 7.0; hydrochloric acid having a low pH and hydrogen peroxide having a high pH might be considered highly corrosive. Occasionally, the material used to fabricate the seal device is not compatible with the corrosive nature of the fluid contained in the flow line. Corrosion causes the seal device to deteriorate and, unless it is timely replaced, fluid leakage or subsequent seal blow-out can occur. Also, the temperature and pressure of the corrosive fluid could accelerate the rate by which the seal device deteriorates. Sometimes a single flow line is used to transport two or more types of fluids at different times. The material used to fabricate the seal device might be compatible with one type of fluid but not the other. Thus, one fluid could cause the seal device to corrode and, subsequently, it could fail.

To compress the seal device between the flanged end-connections of the joined pieces in the flow line, fasteners, such as a common nut and bolt combination, are often used. Although installation instructions of a particular seal device might include specific torque requirements for proper sealing, an installer still might apply too much torque or too little torque. It is also possible that even if the correct range of torque is applied to the fasteners, the amount of compression force is distributed unevenly around the seal device. When compressed, the seal device then may not deform in a uniform manner. Thus, improper torqueing of the fasteners to compress the seal device may result in leakage of the fluid from the flow line.

Particularly in industrial applications, a seal device is not recommended for reuse after it has been removed from operations. This is due to the fact that the material used to fabricate the seal device deforms when it is compressed between the joined pieces in a flow line. The material deforms within its modulus of elasticity during operations but does not recover fully thereafter. If this used seal device is placed back into operation, it is possible that further compression of it will extend beyond its modulus of elasticity thus destroying its sealing capabilities.

Furthermore, during operations, the seal device is acted upon by the hydrodynamic and hydrostatic forces exerted by the fluid. Generally, such forces act on commonly known seal devices in a manner that cause the seal device to expand radially outwardly, that is, in the plane of the flanges. Little, if any, of these forces is directed towards improving the sealing characteristics of the seal device.

It is possible in some applications that the temperature and/or the pressure of the fluid might fluctuate throughout a range. Temperature and/or pressure fluctuations can cause thermal and mechanical expansion and contraction of the material comprising the seal device. Unless the material chosen for fabrication of the seal device has been selected with these design considerations in mind, it is possible that the sealing device could lose its sealing capabilities due to material fatigue caused by numerous cycles of thermal and mechanical expansion and contraction.

Given the problems in seal devices as stated above, a need exists to improve seal technology. It would be advantageous if an improved seal device could be designed for improved sealing capability by utilizing the hydrodynamic and hydrostatic forces of the fluid contained in the flow line. It would also be advantageous if the sealing device could be fabricated from corrosion resistant materials which could resist corrosion in a highly corrosive environment. Another need in the current seal technology would be to provide a seal device that is less sensitive to exacting torqueing requirements so that there is no effect upon the performance of the seal device as a result thereof. Another need would be to provide a seal device that can be reused even though it has been used in prior operations.

Another need would be to provide an improved seal device that would be generally insensitive to expansion and contraction cycles due to fluctuations in temperature and/or pressure. Another need would be to produce a seal device which would be compatible with a variety of fluids regardless of their corrosive nature, temperature and/or pressure. The present invention is directed to such an improved seal device.

One such solution to these problems is outlined in U.S. Pat. No. 5,518,257, entitled “Seal Device for Flow Line Applications”, (hereinafter, “the '257 patent”). The '257 patent relates to a seal device comprising an inner seal member and an outer seal retainer member surrounding the inner seal member. The inner seal member has a central opening extending therethrough to accommodate the flow of the fluid and has a channel structure that provides a channel opening that faces the central opening and extends therearound. Two lips are disposed opposite each other and extend around an inner peripheral portion of the inner seal member. The lips operate to apply a sealing force against the joined pieces when interposed and compressed therebetween. The inner seal member is operative to prevent contact of the fluid with the outer seal retainer member when interposed and compressed between the joined pieces.

The '257 patent further discloses the use of elastomeric energizing elements, which, in certain applications, will limit the usefulness of the seal device. First, this limits the temperature rating of the gasket as compared to the present invention. Second, all elastomers are subject to the phenomenon known as compression set. This phenomenon is the loss of resiliency and conformance to the original shape of the material. For this reason, the gasket in the '257 patent would be limited in temperature and would tend to lose its ability to compensate for cyclical operating conditions when compared to the current invention.

Further, in the '257 patent, the energizing element is used to provide support to the seal member to force expansion into the sealing faces. While this provides benefit in that the sealing faces receive additional sealing force from the energizing element, there are other areas of the seal which would benefit more from this additional sealing force. For example, it would be desired to provide an additional sealing force to a point radially outward of the sealing lips toward the outer diameter of the seal element.

### SUMMARY OF THE INVENTION

In a first aspect of the present invention, a seal device adapted for placement between two flanges is provided comprising an annular seal member having two faces, and inner radius defining a central aperture, and an outer radius defining the radially outer edge of the seal member, a radially inner channel formed between said faces and being open to said central aperture, and a radially outer groove open to the radially outer edge of said seal member, a seal retainer surrounding said seal member and located radially outward therefrom, said seal retainer being sized to engage and extend at least partially into the radially outer groove on said seal member, and a resilient member disposed within said annular seal member between a radially innermost portion of said seal retainer and a radially innermost portion of said groove, wherein said radially innermost portion of said seal retainer contacts and supplies a force to said resilient member.

In a further embodiment of the present invention, the resilient member comprises a circular cross section and a portion of said groove is dimensioned to accept the contour of said resilient member.

In another embodiment of the present invention, the thickness of said seal member is greater than the thickness of said seal retainer when the seal is in a relaxed state, and the thickness of said seal member is equal to the thickness of the seal retainer when the seal and retainer are compressed between two flanges.

In a preferred embodiment of the present invention, the resilient member comprises a coiled metallic spring. Further, the cross sectional diameter of said resilient element is greater than the thickness of said channel.

In another preferred embodiment of the present invention, the seal member comprises an elastomeric extrusion. More preferably, the seal member comprises a corrosion-resistant material. Most preferably, the corrosion-resistant material is selected from a group consisting of: polymers, polyetheretherketone, perfluorelastomers, polytetrafluorethylene. The seal retainer member is preferably fabricated from a rigid material.

In yet another embodiment of the present invention, the seal member further comprises two sealing lips formed form the portion of the seal retainer between the radially inner channel and said first face and said radially inner channel and said second face. In one aspect of the present invention, the sealing lips comprise a rectangular cross sectional shape. In another aspect of the present invention, the sealing lips comprise a triangular cross sectional shape.

In an additional embodiment of the present invention, the sealing force partially comprises force supplied through the interaction of a pressurized fluid acting on the interior surfaces of the flange within the annular channel. In another embodiment of the present invention, the sealing force increases as the pressure supplied by the pressurized fluid increases within the annular channel.

One object of the present invention is to provide a seal that will maintain a tight seal during cycling conditions.

A further object of the present invention is to provide a seal that will maintain good sealing properties with relatively low face loads applied.

An additional object of the present invention is to provide a seal that can be reused and rebuilt.

A further object of the present invention is to provide a seal with a resilient element which serves to energize additional sealing area inboard of the retainer ring and outboard of the sealing lips.

Another object of the present invention is to provide a seal that will provide improved sealing performance as the media pressure increases in the process flow line.

Thus, there has been outlined, rather broadly, the more important features of the invention in order that the detailed description that follows may be better understood and in order that the present contribution to the art may be better appreciated. There are, obviously, additional features of the invention that will be described hereinafter and which will form the subject matter of the claims appended hereto. In this respect, before explaining several embodiments of the invention in detail, it is to be understood that the invention is not limited in its application to the details and construction and to the arrangement of the components set forth in the following description or illustrated in the drawings. The invention is capable of other embodiments and of being practiced and carried out in various ways.

It is also to be understood that the phraseology and terminology herein are for the purposes of description and should not be regarded as limiting in any respect. Those skilled in the art will appreciate the concepts upon which this disclosure is based and that it may readily be utilized as the basis for designating other structures, methods and systems for carrying out the several purposes of this development. It is important that the claims be regarded as including such equivalent constructions insofar as they do not depart from the spirit and scope of the present invention.

So that the manner in which the above-recited features, advantages and objects of the invention, as well as others which will become more apparent, are obtained and can be understood in detail, a more particular description of the invention briefly summarized above may be had by reference to the embodiment thereof which is illustrated in the appended drawings, which drawings form a part of the specification and wherein like characters of reference designate like parts throughout the several views. It is to be noted, however, that the appended drawings illustrate only preferred and alternative embodiments of the invention and are, therefore, not to be considered limiting of its scope, as the invention may admit to additional equally effective embodiments.

### BRIEF DESCRIPTION OF THE DRAWINGS

FIG. 1 is a side view of a seal assembly in an embodiment of the present invention.

FIG. 2 is a partial cross sectional view of the seal assembly of FIG. 1 taken along line I-I in a relaxed or uncompressed state in an embodiment of the present invention.

FIG. 3 is a partial cross sectional view of a seal assembly compressed between two flanges in an embodiment of the present invention.

FIG. 4 is a partial cross sectional view of a seal assembly compressed between two flanges in an embodiment of the present invention.

FIG. 5 is a partial cross sectional view of a seal assembly compressed between two flanges in an embodiment of the present invention.

### DETAILED DESCRIPTION

The present invention generally concerns seal devices which may be inserted between joint connections in a flow line system and is specifically directed to seal devices which are corrosion resistant and affected by hydrodynamic and hydrostatic forces of the fluid contained in a flow line system. It should be appreciated, however, that the seal device technology described herein could be used for seal device applications other than in flow lines. While the exemplary embodiments of the present invention are further described with respect to an annular seal device to be interposed and compressed between flanged-end connections of adjacent pipe sections, it should be understood at the outset of this description that the features and benefits encompassed in the present invention may be applied to seal devices having other configurations, other flow line applications and other joint connections. For example, the features and benefits of the seal device of the present invention may be applied to a seal device to be interposed and compressed between an oil pan and block of an internal combustion engine. One of ordinary skill in the art should readily be able to implement the features and benefits described with respect to the present invention in numerous situations requiring the use of seal devices.

Referring now to the figures, in a first aspect of the present invention, the seal device comprises an annular seal member 10, having a radially inner channel 20 and a radially outer groove 14. Thus, in a preferred embodiment of the present invention, the annular seal member 20 had a generally “H-shaped” cross section. A resilient element 30 is positioned within the radially innermost portion of the groove 14, and in a preferred embodiment of the present invention, the radially innermost portion of the groove 14 comprises a circular recess 32 formed to conform to the contour of the resilient member 30. An annular seal retainer 40 surrounds the radially outer portion of the seal member and a portion of the seal retainer extends into the radially outer groove 14 of the seal member 10. The seal retainer 40 functions to hold the resilient element 30 in place within the recess 32 formed in the seal member 10.

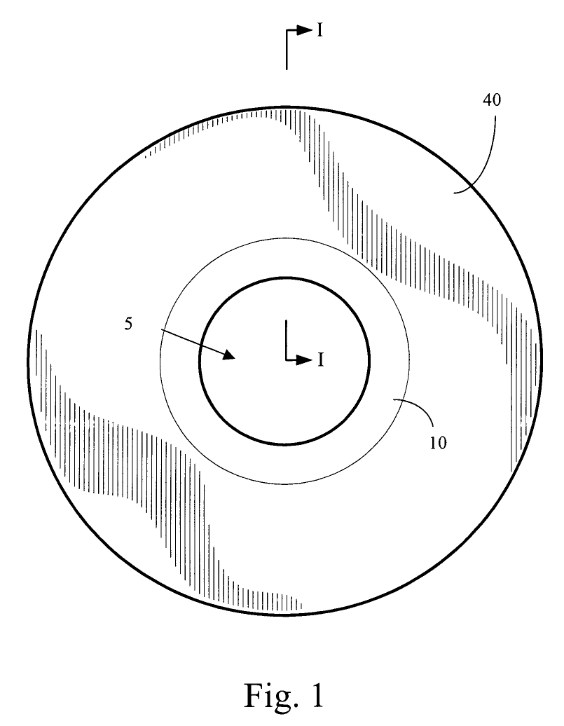

The seal device is positioned between two flanges 50, for example, at the juncture between two lengths of pipe. The faces 12 of the seal member 10 contact and provide a fluid seal between said flanges 50. The seal device further comprises an inner aperture 5 extending through the center of the seal, as illustrated in FIG. 1, corresponding to the fluid flow line through the pipe.

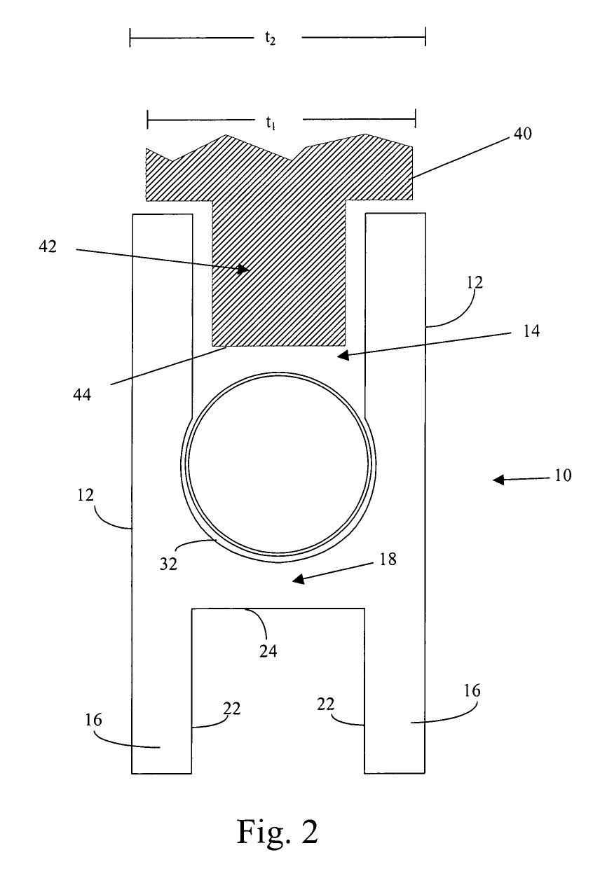

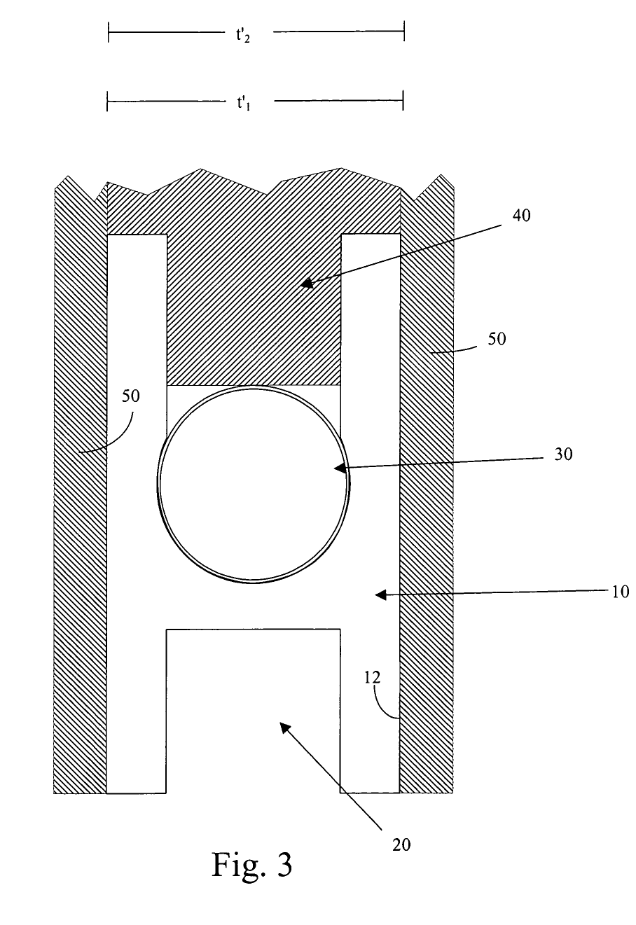

FIG. 2 illustrates a seal device in a partially relaxed state, i.e. not compressed between two flanges. As shown here, the seal retainer 40 comprises a select seal retainer thickness t₁ and the seal member 10 comprises a select seal member thickness t₂ which is greater than the seal retainer thickness t₁ when in the relaxed state. FIG. 3 illustrated the same seal device compressed between two pipe flanges. As shown here, the seal retainer thickness t′₁ is substantially equal to the seal member thickness t′₂ when interposed and compressed into a compressed state between the joined pieces in the flow line.

The channel 20 in the seal member 10 is open and exposed to the central aperture of the seal and therefore to the interior of the fluid flow line. The fluid fills the channel 20 and exerts a force on the interior walls 22, 24 thereof. The area between the side walls 22 of the channel 20 and the faces 12 of the seal member 10 form sealing lips 16. The force of the fluid on the side walls 22 forces the lips 16 axially outward thereby creating additional sealing force on the flanges 50. As system pressure increases, the forces on the side walls 22, and the corresponding lips 16, will increase as well to create a tighter seal between the lips 16 and flange surface 50.

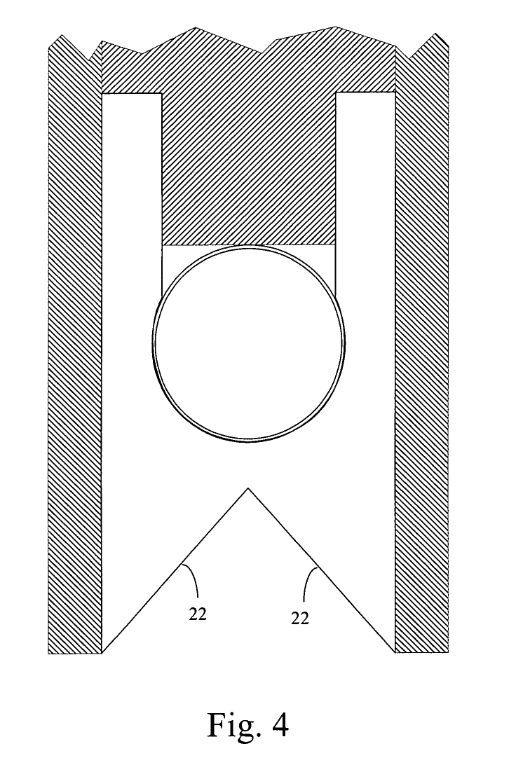

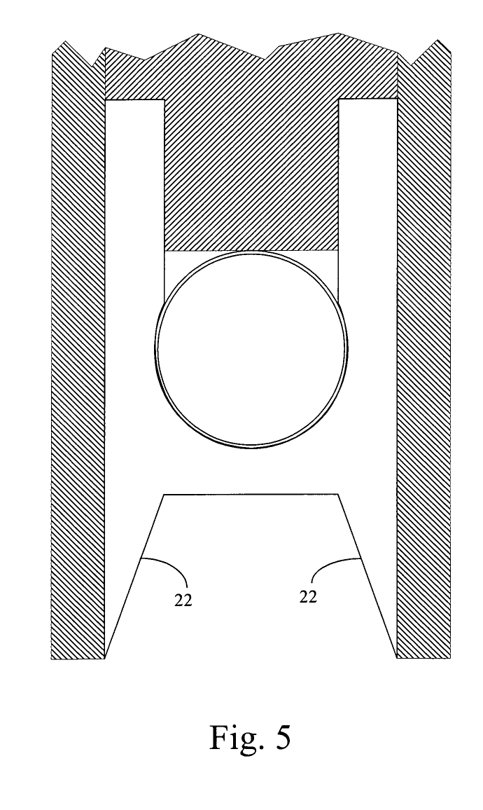

In a further embodiment of the present invention, illustrated in FIGS. 4 and 5, the geometry of the channel 20 is varied. In FIG. 4, the channel 20 comprises a “V-shaped” cross section wherein the side walls 22 angle inward to a point. In FIG. 5, the channel 20 comprises a trapezoidal cross section wherein the side walls 22 are angled inward but meet a rear wall 24. Further geometries for the channel 20 are consistent with the intent of this invention as long as they provide force or a component of force in a direction parallel to the central axis of the gasket to cause a seal between the sealing lips and the flange surfaces.

In one embodiment of the present invention, the seal member 10 comprises a suitable sealing material, which may vary depending upon the particular sealing application. As an example, these materials include any compressible material suitable for sealing fluids such as: elastomers, metals, resins, and polymers such as polyetheretherketone, perfluorelastomers, and polytetrafluorethylene. In a preferred embodiment of the present invention, the seal member 10 comprises polytetrafluoroethylene (PTFE).

A thinner section 42 of the seal retainer 40 protrudes into the groove 14 to create a final restraining surface 44 to contact and restrain the resilient element 30. This seal retainer 40, and the manufacturing tolerances of the seal member, insures that the space available for the resilient element 30 is controlled in a direction parallel to the central axis of the gasket. This configuration operates to control the amount of compression applied by mating sealing surfaces to the gasket in a direction parallel to the central axis of the gasket.

As such, the seal member 10 and seal retainer 40 are sized and adapted to seal a space between joined pieces of pipe and allow fluid to flow therethrough without leakage. The seal member 10 is operative to provide a seal against the pipe flanges and prevent contact of the fluid with the resilient element 30 and seal retainer 40. Therefore, it is not necessary for the seal retainer 40 to be constructed of a corrosion resistant material when the seal device is used in a highly corrosive environment.

In a preferred embodiment of the present invention, the seal retainer 40 comprises a rigid material selected from a group of materials comprising metal and glass-reinforced epoxy which resist compressive forces. This allows the seal retainer 40 to act as a compression limiter so that regardless of the amount of torque applied to the flange bolts, the force applied to the seal device by the flanges will not over compress and destroy the sealing properties of the seal member 10.

A support wall 18 is provided comprising the area of the seal member 10 located between the radially outer wall 24 of the channel 20 and the radially innermost portion of the resilient element recess 32. This support wall 18 controls the inward radial deflection of the resilient element 30 when compressive force is applied. By capturing the resilient element 30 within a confined and controlled space, its deformation can be controlled. By controlling the deformation, the stresses in the material can be more evenly distributed to prevent localized yielding of the resilient element 30 material. By preventing material yield, the resilient properties are maintained and thus the ability to compensate for operational cycling is maintained.

In a preferred embodiment of the present invention, the resilient element 30 comprises a flat, thin, steel wire formed into a helical spring. However, one skilled in the art will recognize that alternate materials and shapes could be used for the spring 30 as long as those materials and shapes exhibited both deformable and resilient characteristics. For example, the spring could comprise any suitable material that is formable into a helical spring. Additionally, the principles of concentrating the loading on the spring would be applicable even if other types of springs were used such as elastomer o-rings, x-rings, etc.

In addition to providing controlled deformation, the captured spring element 30 allows for efficient transfer of compressive forces for creating a seal between the faces 12 of the seal member 10 and the flanges 50. By preventing localize yielding of the spring material, all the forces required to compress the seal member and thus the spring are maintained and not lost in permanent deformation of the spring material. Additionally, the relatively small area of contact between the spring 30 and the seal retainer 40 concentrates the applied load. Further, the channel 20 as described above creates additional sealing forces as system pressure is applied. For this reason, the spring will not have to provide enough force to seal the full system pressure. These features allow lesser face loads to be used to achieve the same sealing tightness when compared to other sealing devices.

In a preferred embodiment of the present invention, the gasket disclosed is rebuildable. The retainer ring is made of a rigid material to resist compressive forces. Additionally, it is protected from the process media by the seal member. Therefore, after use, the retainer ring could be utilized with a new seal member and spring to create a new gasket. In a further embodiment of the present invention, the gasket can be removed and reinstalled in a process flow line and continue to provide a suitable seal. This is because the spring 30 is not permanently deformed during operation and will continue to supply sealing force to the seal member.

Although the present invention has been described with reference to particular embodiments, it should be recognized that these embodiments are merely illustrative of the principles of the present invention. Those of ordinary skill in the art will appreciate that the apparatus and methods of the present invention may be constructed and implemented in other ways and embodiments. Accordingly, the description herein should not be read as limiting the present invention, as other embodiments also fall within the scope of the present invention.

1. A seal device adapted for placement between two flanges, comprising:
(a) an annular seal member having two faces, and inner radius defining a central aperture, and an outer radius defining the radially outer edge of the seal member, a radially inner channel formed between said faces and being open to said central aperture, and a radially outer groove open to the radially outer edge of said seal member;
(b) a seal retainer surrounding said seal member and located radially outward therefrom, said seal retainer being sized to engage and extend at least partially into the radially outer groove on said seal member; and,
(c) a resilient member disposed within said annular seal member between a radially innermost portion of said seal retainer and a radially innermost portion of said groove;
wherein said radially innermost portion of said seal retainer contacts and supplies a force to said resilient member.

2. The seal device of claim 1 wherein said resilient member comprises a circular cross section and a portion of said groove is dimensioned to accept the contour of said resilient member.

3. The seal device of claim 1 wherein the thickness of said seal member is greater than the thickness of said seal retainer when the seal is in a relaxed state.

4. The seal device of claim 1 wherein the thickness of said seal member is equal to the thickness of the seal retainer when the seal and retainer are compressed between two flanges.

5. The seal device of claim 1, wherein said resilient member comprises a coiled metallic spring.

6. The deal device of claim 1, wherein the cross sectional diameter of said resilient element is greater than the thickness of said channel.

7. The seal device of claim 1, wherein said seal member comprises an elastomeric extrusion.

8. The seal device of claim 1, wherein said seal member comprises a corrosion-resistant material.

9. The seal device of claim 8, wherein said corrosion-resistant material is selected from a group consisting of: polymers, polyetheretherketone, perfluorelastomers, polytetrafluorethylene.

10. The seal device of claim 1, wherein said seal retainer member is fabricated from a rigid material.

11. The seal device of claim 1, wherein said seal member further comprises two sealing lips formed form the portion of the seal retainer between the radially inner channel and said first face and said radially inner channel and said second face.

12. The seal device of claim 11, wherein said sealing lips comprise a rectangular cross sectional shape.

13. The seal device of claim 11, wherein said sealing lips comprise a triangular cross sectional shape.

14. The seal device of claim 11, wherein said sealing force partially comprises force supplied through the interaction of a pressurized fluid acting on the interior surfaces of the flange within the annular channel.

15. The sealing device of claim 14, wherein said sealing force increases as the pressure supplied by the pressurized fluid increases within the annular channel.
